(19) United States
(12) Patent Application Publication
(10) Pub. No.: US 2020/0164601 A1
(43) Pub. Date: May 28, 2020

(54) JOINING PUNCH FOR A JOINING DEVICE AND A JOINING DEVICE

(71) Applicant: Manz AG, Reutlingen (DE)

(72) Inventor: Martin FREUNDT, Esslingen (DE)

(73) Assignee: Manz AG, Reutlingen (DE)

(21) Appl. No.: 16/693,937

(22) Filed: Nov. 25, 2019

(30) Foreign Application Priority Data
Nov. 26, 2018 (DE) 10 2018 129 806.4

(51) Int. Cl. B29C 65/00; B29C 65/56; B29C 65/48

(52) U.S. Cl. CPC B29C 66/812; B29C 65/565; B29L 2031/3481; B29C 66/9261; B29C 65/4825

(57) ABSTRACT

A joining punch for a joining device for producing a joining connection, in particular an adhesive connection, between a first joining part, for example a cover glass, and a second joining part, for example a housing, has at least one force-receiving part to which a contact force can be applied and having at least two pressing parts for applying pressure to the first joining part. The at least two pressing parts are arranged and/or formed independently of one another on the joining punch in such a manner that they are tiltable relative to the force-receiving part. The joining punch is embodied in a joining device. The two joining parts can be pressed together according to a nominal distribution of the forces or pressures, in particular uniformly using the joining device. Unevennesses and deformations of the joining parts, in particular of the first joining part, can be compensated.

### CROSS-REFERENCE TO RELATED APPLICATIONS

This application claims priority under 35 USC 119 of German Application No. DE 10 2018 129 806.4, filed on Nov. 26, 2018, the disclosure of which is herein incorporated by reference.

### BACKGROUND OF THE INVENTION

The invention relates to a joining punch for a joining device for producing a joining connection, in particular an adhesive connection, between a first joining part, for example a cover glass, and a second joining part, for example a housing.

Smartphones, mobile computers and similar devices usually have a display unit. In this case, a cover glass is usually connected, in particular glued, to a housing located under the cover glass and/or to a display layer located under the cover glass.

In order to obtain the largest possible presentation area of the display unit, the adhesive agent is usually applied to an edge region, the edge region being as narrow as possible, of the housing or display layer.

In particular, thermally activated adhesive films, laser activated adhesive agents and/or pressure activated adhesives (PSA) are used as adhesive agents.

These adhesive agents require defined pressure and temperature conditions to produce a permanent joining connection.

For this purpose, the respective adhesive agent is inserted between the two joining parts, in particular in the respective edge region, and optionally, depending on the kind of the adhesive agent, is applied under pressure and temperature, in such a manner that the adhesive agent is bonded to at least one of the two joining parts. Subsequently, the two joining parts are pressurized using a joining punch or, respectively, pressed against each other using a defined clamping pressure, wherein, depending on the kind of the adhesive agent, the latter and/or the joining parts must be tempered simultaneously.

For a high-quality joining connection, the forces or pressures exerted on the joining parts should generally be distributed as evenly as possible or at least in a predictable manner over the respective edge regions.

However, joining parts—for example in smartphones for design reasons—are often curved rather than flat at their edge regions. Due to production tolerances, the joining parts also often have slight unevennesses. Due to the pressure and heat applied during the joining process, the joining parts can additionally—at least locally—deform.

As a result of these interferences, pressure distributions are often uneven and, generally speaking, they deviate from a specified nominal distribution, so that the quality and durability of the joining connection have so far been affected.

In order to be able to process the greatest possible variety of different joining parts or assemblies of joining parts, it should also be possible to provide individually adapted joining punches quickly and cost-effectively. The joining punch should be suitable for both small and large assemblies, such as wristwatch assemblies, smartphones, rear-view mirrors and/or televisions.

### SUMMARY OF THE INVENTION

The object of the invention is therefore to provide a joining punch which can be produced cost-effectively and used in a wide variety of applications, which can be used to produce a particularly high-quality joining connection, as well as a joining device having such a joining punch.

The object is solved by a joining punch for a joining device for producing a joining connection, in particular an adhesive connection, between a first joining part, for example a cover glass, and a second joining part, for example a housing, having at least one force-receiving part to which a contact force can be applied, and having at least two pressing parts for applying pressure to the first joining part, wherein the at least two pressing parts are each arranged and/or formed independently of one another on the joining punch in such a manner that they are tiltable relative to the force-receiving part.

Such a joining punch can be supplied with a desired contact force via its force-receiving part. During operation, the joining punch can contact the first joining part indirectly and/or directly via at least one, preferably all, pressing parts. The contact force can then be applied spatially distributed to the first joining part via the pressing parts—in particular via their contact points on the first joining part—, so that the first joining part is pressed against the second joining part.

The joining punch may be configured in such a manner that it works in a vertical or at least substantially vertical direction. For this purpose, the force-receiving part can be arranged and/or formed in the region of a top side of the joining punch. In a similar manner, it is also conceivable that the joining punch is configured in such a manner that it works in a non-vertical direction, in particular a horizontal or at least substantially horizontal direction.

At least one pressing part may be arranged in the region of a bottom side of the joining punch. At least one pressing part may be formed as a single part. Alternatively, one or a plurality of pressing parts may also be formed as part of another member of the joining punch. At least one pressing part may be formed from a different material or have a different material than at least one other pressing part. At least one pressing part may be connected to another pressing part, in particular on the bottom side. For example, at least two, in particular all, pressing parts may be interconnected on the bottom side. The pressing parts can be connected by means of an elastically deformable material, e.g. a rubber-containing and/or a rubber-like material.

Thereby, the joining punch offers a plurality of degrees of freedom, along which the at least two pressing parts can be moved relative to the force-receiving part, in particular tilted. This means that when the joining punch contacts the first joining part—in particular via its pressing parts—and pressurizes it, the alignments or orientations of the pressing parts can automatically adapt to the respective local contour of the contacted joining part. Each pressing part can thereby form its own joining punch foot, the joining punch foot being adjustable in regard to its alignment and orientation. Local unevennesses and/or deformations of the contacted joining part can thereby be compensated by a plurality of pressing parts—each of which may be aligned differently—in such a manner that the influences of these irregularities on the distribution of the applied forces or pressures are minimized. The quality and durability of the joining connections created using a joining punch according to the invention can thereby be improved.

Such a joining punch nevertheless has a relatively simple structure and can therefore be produced cost-effectively.

The geometry and/or the structure of the joining punch can be selected depending on a desired nominal distribution of the applied forces or pressures. For example, the orientation and/or the position of at least one of the two pressing parts relative to the force-receiving part can be selected depending on the desired nominal distribution.

The joining punch can have at least one, in particular beam-shaped, load-conducting part which is arranged between at least one of the two pressing parts and the force-receiving part, wherein preferably the load-conducting part is arranged and/or formed on the joining punch in such a manner that it is tiltable relative to the force-receiving part.

By using one or a plurality of load-conducting parts, more than two pressing parts can be easily arranged and/or formed on the joining punch, particularly in such a manner that they are tiltable relative to the force-receiving part.

In particular, the joining punch may have a tree structure. A plurality of load-conducting parts may be arranged hierarchically for this purpose. A load-conducting member may be arranged and/or formed on a load-conducting part of a higher level or on the force-receiving part, in particular in such a manner that it is tiltable. Therefore, the force distribution structure can have a plurality of levels, which can be formed in particular by one or a plurality of load-conducting parts. Via a load-conducting part, a force applied to the load-conducting part from a higher level can then be transferred to load-conducting parts and/or pressing parts in a level below the load-conducting part, in particular in the manner of an inverted weighbeam.

This means that the contact force can be transferred to the first joining part via a plurality of pressing parts. Even minor local deformations of the joining part can be compensated. The distribution of the contact forces or pressures can also be finely adjusted, especially with a large number of pressing parts.

The number and height of the levels can be selected depending on the production method, in particular depending on the minimum required or minimum producible structure and/or gap widths, and/or depending on the material characteristics of the joining punch, in particular its elasticity behavior. For example, minimum gap widths in the range of 25 to 100 μm can be produced by eroding. As a result, the required structures can be miniaturized.

It is conceivable that at least one pressing part and/or one load-conducting part are arranged and/or formed on the joining punch in such a manner that they are tiltable via a joint part. The joint part can be arranged or formed directly on the pressing part or on the load-conducting part. Alternatively, the joint part can also be arranged at a distance from the pressing part or the load-conducting part. For example, it can be arranged or formed between two load-conducting parts. The joint part may be formed as a separate single part.

In a particularly preferred embodiment of the invention, the joint part may be formed as a constriction. The joint part can generally be formed as part of another member of the joining punch, e.g. a load-conducting part. For this purpose, this part can be a constriction of this other member. In this case it is advantageous if the material is elastically deformable, at least in the region of the joint part.

Alternatively or complementary, the joint part can be designed in order to reduce the bending stiffness locally. For this purpose, the joint part may have a material weakening and/or be formed in such a manner. The joint part can have a combination of different materials and/or be made of such a material combination. Also, the joint part can generally have a shape that is designed to reduce bending stiffness locally.

Typically, the cross-sections of the joining parts to be joined, for example in the case of a display unit of a smartphone, are at least substantially rectangular. In some cases, for example in the case of smartwatches, the cross-sections of the joining parts can also be at least substantially elliptical, particularly circular. Accordingly, the edge regions to which forces or pressures are applied are also typically rectangular, elliptical or at least substantially rectangular or elliptical.

It is therefore advantageous if the pressing parts are arranged across an area, in particular across a polygonal, an at least substantially polygonal, an elliptical or an at least substantially elliptical surface and/or along a surface contour of this kind. The pressing parts can therefore contact the first part not only in a straight line, for example only along one side of the first joining part, but also across an area, for example along the respective edge regions or at least over a large part of the mentioned edge regions.

For this purpose, the joining punch may have a spatial structure, for example a ring-shaped or polyhedron-shaped structure or at least a substantially ring-shaped or polyhedron-shaped structure. One or a plurality of intermediate parts can then not only be arranged parallel or substantially parallel to one another and/or to the force-receiving part. Instead, one or a plurality of intermediate parts can also be arranged at an angle to one another and/or to the force-receiving part. For example, an intermediate part can connect two longitudinally running partial regions of the joining punch. As a result, there are further adjustment possibilities for adjusting the force or pressure distribution applied to the first joining part by the joining punch.

The joining punch can taper in a direction parallel to the clamping direction, in particular towards the force-receiving part. Therefore, a free space can be left or created for further components of a joining device in which the joining punch is used. Such a further component can be a heating member, for example a beam source, in particular a laser, for the input of heat energy into at least one of the joining parts and/or into an adhesive layer located between the joining parts. Alternatively or complementary, a component of the joining device can act through the free space; for example, the laser can beam through the free space using its laser beam onto and/or through one of the joining parts.

At least one load-conducting part and/or the force-receiving part may have a reinforcing section, in particular for stiffening parallel to the clamping direction. This improves the bending stiffness of the respective load-conducting part or force-receiving part. Parasitic forces due to a spring effect, in particular due to spring-elastic deformation of the load-conducting part or the force-receiving part, can therefore be avoided or at least reduced. For this purpose, the load-conducting part and/or the force-receiving part can be formed as bend-resistant beams, in particular along the clamping direction. The reinforcing section can be formed as a thickening on the load-conducting part or, respectively, on the force-receiving part.

A particularly flexibly adjustable pressure or force distribution can be achieved if at least one load-conducting part is arranged and/or formed in an asymmetrically hinged manner. If, for example, a beam-shaped load-conducting part is mounted on another load-conducting part via a joint part, it is possible for the joint part to engage with the load-conducting part outside the center of the beam-shaped load-conducting part. Therefore, the force applied to the beam-shaped load-conducting part can be divided and transferred to a level below the beam-shaped load-conducting part according to the inverse ratio of the lengths of the parts of the load-conducting part delimited by the joint part to its total length.

A pressing part can directly engage or contact a joining part.

However, it is also conceivable that the joining punch has a, preferably elastically deformable, force transmission member in the region of at least one of the pressing parts. The force transmission member can be formed in order to transfer the (partial) contact force of at least one pressing part to a joining part located underneath, in particular to the first joining part. The force transmission member may have or be made of a material which is compatible with the joining part located underneath or at least with its surface. If, for example, the joining part has a glass surface, the material can be selected in such a manner that it is non-scratching.

For example, the force transmission member can form a layer between the region of the at least one pressing part and the respective joining part. In particular, the force transmission member can cling to the contour of the joining part, for example due to its elasticity. As a result, an even distribution of the forces or pressures transferred to the joining part can be achieved.

In addition, it is conceivable that at least one pressing part is embedded and/or can be embedded at least partially in the force transmission member. For this purpose, the force transmission member may have at least one connection point for receiving the at least one pressing part or at least a section of the at least one pressing part. For this purpose, the connection point can be formed as a bore. The connection point can be configured for the form-fit connection of the pressing part. The connection point can also be configured in such a manner that the pressing part can be jammed, anchored and/or latched. Alternatively or complementary, the pressing part may be injection-molded and/or molded onto the force transmission part, in particular at and/or in the connection point.

In a particularly advantageous class of embodiments of the invention, at least one load-conducting part may have a controllably deformable material, for example a bimetal, and/or at least one load-conducting part may be formed from such a controllably deformable material. If, for example, the controllably deformable material is a bimetal, the load-conducting part can be deformed by heating the controllably deformable material, especially in a reversible manner. The deformation can be reversed by cooling. A control laser, for example in the form of a laser scanner, can be used for heating. Alternatively or additionally, the heating can also be performed by means of an electrically operated heating member, for example a resistance member. The controllably deformable material can also be a memory form material. This results in a further adjustment possibility for adjusting the joining punch to different geometries or contours of one or both joining parts, which can also be used during the operation of the joining punch. For this purpose, the load-conducting part may have a control surface for the reception and/or output of energy, in particular heat.

A plurality of load-conducting parts and/or the force-receiving part may be formed together in one piece. In particular, the joining punch may be formed in one piece.

For this purpose, the joining punch may have at least one part manufactured by 3D printing, injection molding, milling, laser cutting and/or eroding. In particular, the entire joining punch may be manufactured by one or a plurality of these production techniques. For example, the joining punch may be formed as a 3D-printed part.

Alternatively or additionally, it is also conceivable that the joining punch or at least parts of the joining punch are assembled from single parts.

The joining punch, in particular at least one of the load-conducting parts and/or the force-receiving part, may have one or a plurality of materials or be made of one or a plurality of materials.

At least one load-conducting part and/or the force-receiving part can be formed in such a manner that they can be deformed elastically at least partially. By deforming at least one load-conducting part and/or the force-receiving part, pressing parts can then be tilted. This also allows the at least two pressing parts to be arranged independently of one another on the joining punch in such a manner that they are tiltable relative to the force-receiving part.

It is also conceivable that, in particular for adjusting the desired nominal distribution of the applied forces or pressures, at least one load-conducting part and/or the force-receiving part have at least one curvature and/or have a variable cross-section along a respective longitudinal direction.

The scope of the invention also includes a joining device having a joining punch according to the invention. Thereby, the joining punch used can be adapted to the assembly to be joined, in particular to the first and/or to the second joining part. Different joining punches can be provided for processing different assemblies. Different kinds of assemblies or, respectively, joining parts can therefore be processed quickly and with high precision as well as cost-effectively.

Additional features and advantages of the invention may be found in the following detailed description of the exemplary embodiments of the invention, based on the figures of the drawing, which shows details essential to the invention, and in the claims.

The features shown in the drawing are shown in such a manner that the features of the invention can be made clearly visible. The different features may each be realized in variants of the invention either in isolation or together in any desired combinations.

### BRIEF DESCRIPTION OF THE EMBODIMENTS

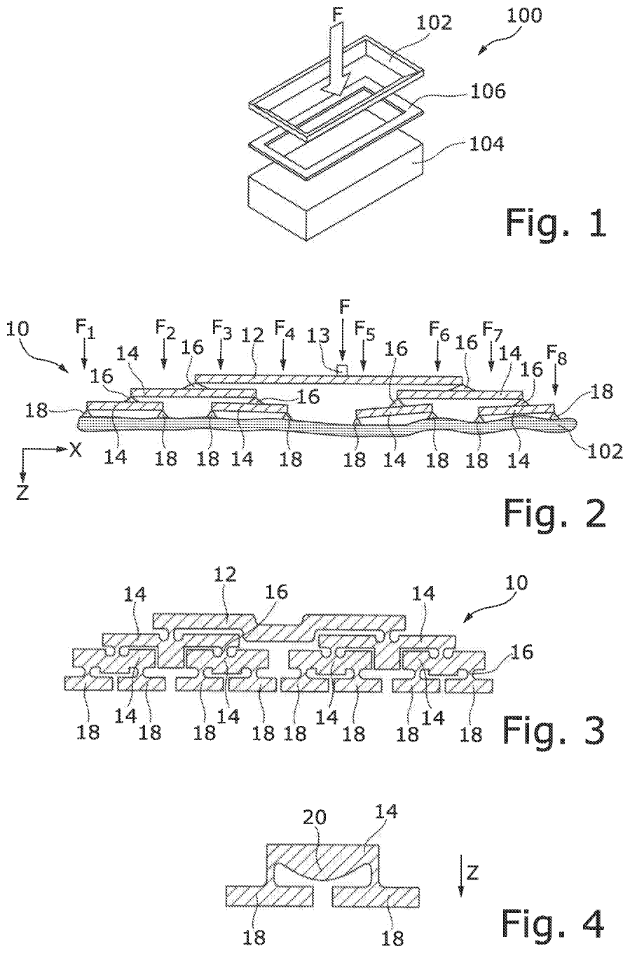

FIG. 1 is a schematic representation of two joining parts to be joined together via an adhesive layer;

FIG. 2 is a schematic cross-sectional view of a joining punch;

FIG. 3 is a schematic cross-sectional view of a single-piece joining punch;

FIG. 4 is a schematic cross-sectional view of a load-conducting part having a reinforcing section;

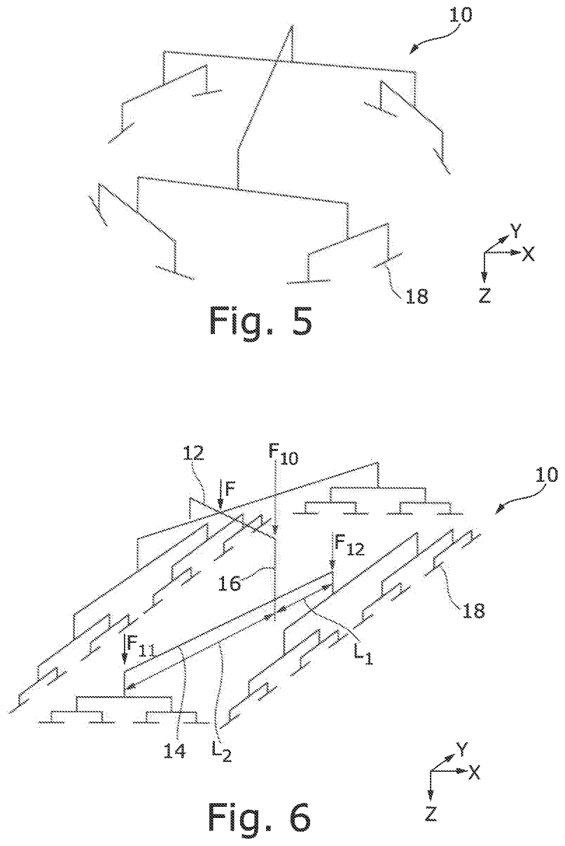

FIG. 5 is a schematic representation of a ring-shaped joining punch in a perspective view;

FIGS. 6-9 are schematic representations of further versions of joining punches each in a perspective view;

FIG. 10 is a schematic cross-sectional view of another joining punch having a force transmission member;

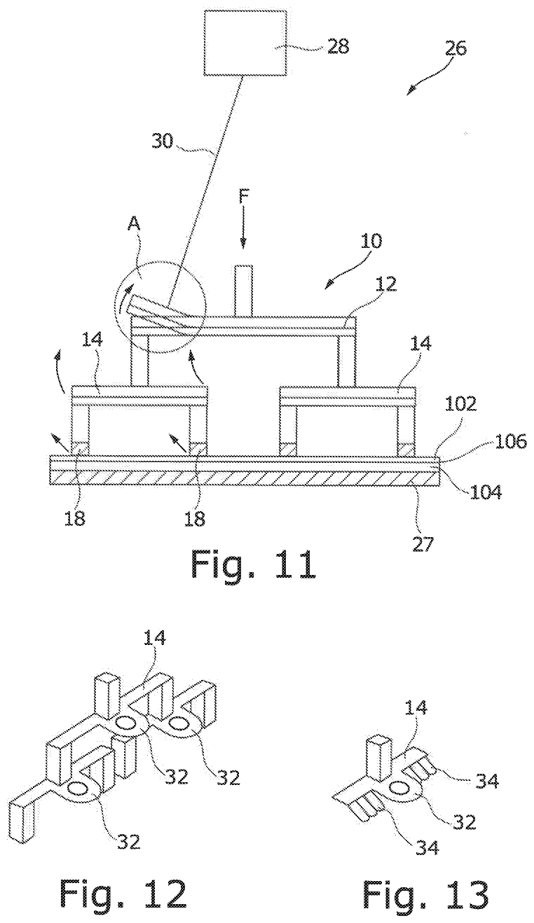

FIG. 11 is a joining device having a control laser;

FIG. 12 is a schematic detailed view of a joining punch for the joining device according to FIG. 11 in a perspective view and

FIG. 13 is a schematic detailed view of a load-conducting part of a joining punch having a control surface and cooling ribs.

### DETAILED DESCRIPTION OF THE EMBODIMENTS

Based on FIG. 1, the initial situation is explained in more detail.

An assembly 100, in particular a display unit of a smartphone, can be seen.

The assembly 100 has a first joining part 102, especially a cover glass. The first joint part 102 or the cover glass is to be glued together using an adhesive agent 106 with a second joining part 104, for example a housing of the smartphone. In the exemplary embodiment shown, the adhesive agent 106 is a thermally activated adhesive film. The adhesive agent 106 is applied along the edges of the first and second joining parts 102, 104—which are substantially rectangular in cross-section—between them. For connecting and curing of the adhesive agent 106, the two joining parts 102, 104 must be clamped together using a contact force F.

For this purpose, a joining punch is fitted from the outside onto the first joining part 102. The contact force F is then applied to the joining punch. For example, the second joining part 104 is fixed either by a second joining punch of analog construction and/or by a work-part carrier.

In order to achieve as homogeneous an adhesive effect as possible, the contact force F should be applied as evenly as possible along the edges of the first joining part 102. Deformations caused by pressure as well as slight waviness of the first joining part 102 can make it difficult to exert uniform force or pressure.

Depending on the application case, it may alternatively be necessary to create a pre-definable nominal distribution of the forces or pressures acting on the joining part(s) instead of a merely uniform distribution. This may be the case, for example, if the width of the adhesive agent 106 varies locally due to, for example, recesses, screw connections or similar requirements.

Based on FIG. 2, the basic idea of the invention is first explained in more detail.

FIG. 2 shows a schematic representation of a first embodiment of a joining punch 10. The joining punch 10 has a force-receiving part 12 which can be applied by the contact force F along a direction z. The force-receiving part 12 is formed as a beam and has a force-receiving point 13 approximately in the center, to which the contact force F is applied during a joining process.

Underneath the force-receiving part 12, a plurality of load-conducting parts 14 are arranged hierarchically in a plurality of levels, in this case in two levels. The load-conducting parts 14 are also formed as beams.

The load-conducting parts 14 are arranged via joint parts 16 on the member located above them, i.e. on a load-conducting part 14 located above them or on the force-receiving part 12, in such a manner that they can be tilted. They are therefore arranged on the joining punch 10 in such a manner that they are tiltable relative to the force-receiving part 12.

Two pressing parts 18 are arranged on each of the load-conducting parts 14 of the lowest level. Using the pressing parts 18, the joining punch 10 contacts the first joining part 102 in the situation according to FIG. 2, which is to be clamped onto the second joining part 104 (FIG. 1).

Due to the tilting arrangements of the load-conducting parts 14, the pressing parts 18 are arranged at least independently of the pressing parts 18 arranged on the respective other load-conducting parts 14 on the joining punch 10 in such a manner that they are tiltable relative to the force-receiving part 12.

It is conceivable that, alternatively or supplementary the pressing parts 18 are arranged, in particular hinged, directly on the respective load-conducting parts 14 of the lowest level in such a manner that they are tiltable.

For clarification purposes, deformations of the first joining part 102 during the joining process are shown in FIG. 2 in a greatly enlarged form.

It can be seen that, when the contact force F is applied to the force-receiving part 12, the pressing parts 18 each press with partial forces F1 to F8 at their respective contact points onto the first joining part 102 or, respectively, transfer the respective partial forces F1 to F8 to it.

Due to the tilting arrangements of the load-conducting parts 14, the load-conducting parts 14 can tilt in such a manner that all pressing parts 18 abut on the first joining part 102 despite its deformations. Therefore, an even force application into the first joining part 102 is possible.

In this exemplary embodiment, the joining punch 10 and its load-conducting parts 14 and therefore its pressing parts 18 run substantially in a straight line along a direction x perpendicular to the direction z, in particular a horizontal direction.

FIG. 3 shows another exemplary embodiment of a joining punch 10. This joining punch 10 is formed in one piece. For this purpose, this joining punch 10 is manufactured by means of 3D printing.

The tilting arrangement of the load-conducting parts 14 on the respective other load-conducting parts 14 or the force-receiving part 12 is achieved by the fact that the respective joint parts 16—only two of which are provided with a reference sign in FIG. 3 for simplification reasons—are formed as constrictions. The joining punch 10 is also made of an elastic or at least limited elastic material, for example metal, in order to avoid breaking in the region of one of the constrictions when the contact force F is applied.

The load-conducting parts 14 can therefore tilt relative to the force-receiving part 12 by (reversibly) bending the respective joint part 16 or the respective constriction.

FIG. 3 further shows that, in the case of this joining punch 10, the pressing parts 18 are also additionally formed on the respective load-conducting parts 14 above, i.e. on the load-conducting parts 14 of the lowest level, by means of a joint part 16, which in turn is formed as a constriction, in such a manner that said pressing parts are tiltable.

FIG. 4 shows a schematic detailed view of a load-conducting part 14 having pressing parts 18 arranged on it. In particular, it can be seen that the load-conducting part 14 is formed as a beam. It has a reinforcing section 20 in a center region. The reinforcing section 20 is formed by thickening along the z direction. The bending stiffness of the load-conducting part 14 is increased by the reinforcing section 20.

In the following FIG. 5 to FIG. 9 further embodiments of joining punches 10 are shown. For simplification, in FIG. 5 to FIG. 9 only one pressing part 18 is provided with a reference mark as a representative of all other pressing parts 18.

In these embodiments the respective pressing parts 18 are arranged spread out over a surface, in particular over a polygonal, an at least substantially polygonal, an elliptical or an at least substantially elliptical surface perpendicular to the direction z and parallel to a plane spanned by the direction x and a direction y perpendicular to the directions x and z.

The joining punch according to FIG. 5 has a ring-shaped spatial structure. Its pressing parts 18 are arranged spread over a circular surface. It is suitable, for example, for processing joining parts having a circular cross-section, for example, as is the case of watches, especially smartwatches.

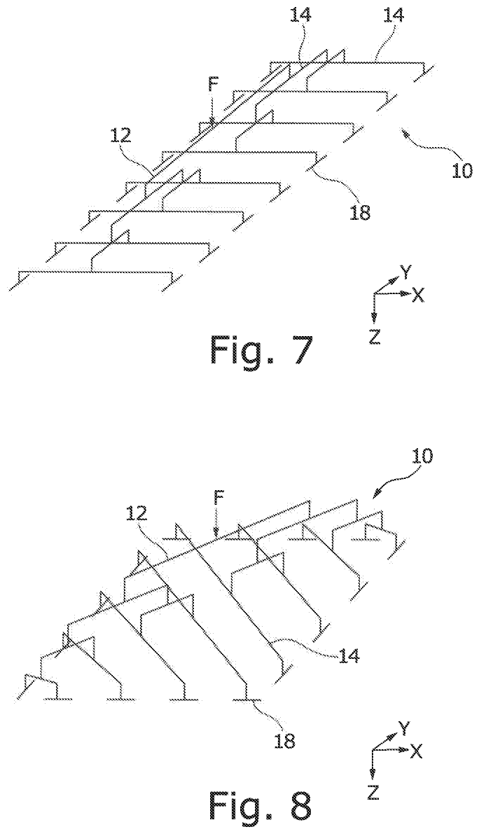

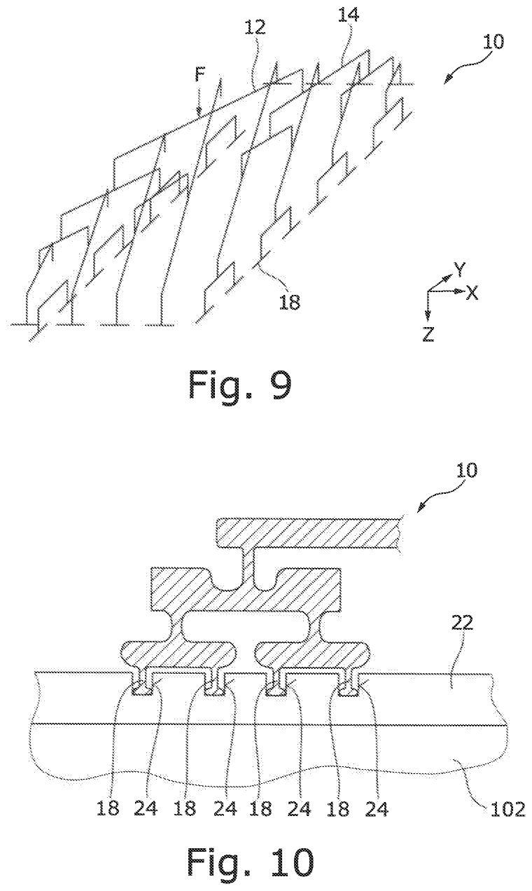

FIG. 6, FIG. 7 and FIG. 8 as well as FIG. 9 show different joining punches 10, which can be used for joining parts that are substantially rectangular in cross-section.

It can be seen in each case that forces can also be spread between different partial regions of the respective joining punches 10 by means of the load-conducting parts 14, of which in FIGS. 6 to 9 only individual examples are provided with reference signs, as well as by the force-receiving parts 12. In particular, the respective contact forces F can also be spread over different, non-linearly arranged partial regions, for example between different longitudinal sides.

By selecting a respective spatial structure, the joining punches 10 can therefore be individually adjusted to the respective requirements of the joining parts 102 or 104 (both FIG. 1).

A further possibility of adjusting or controlling the distribution of the contact force F to the pressing parts 18 results from the asymmetrical hinging of the load-conducting parts 14, as shown in FIG. 6. For this purpose, FIG. 6 shows a load-conducting part 14, which is hinged on the force-receiving part 12 via a joint part 16 in such a manner that it is tiltable. For this purpose, however, the joint part 16 does not engage in the center but in a length ratio L1 to L2 on the load-conducting part 14. Thus, a partial force F10 acting on the joint part 16 is distributed in partial forces F11 and F12 according to the ratios of the lengths L1 and L2 to the total length L1+L2.

In the case of the joining punch 10 according to FIG. 6, which can be used, for example, for joining parts of a display unit, it can be seen that fewer pressing parts 18 are arranged along its narrow sides than along its wide sides. Therefore, if all load-conducting parts 14 were each subjected to forces in the center, the pressing parts 18 would each press with different forces on the first joining part 102 (FIG. 1).

An even distribution or another desired nominal distribution of the forces or pressures exerted by the pressing parts 18 can, however, be achieved by suitable, generally non-centered positioning of the joint parts 16 on the respectively associated load-conducting parts 14.

The joining punch 10 according to FIG. 7 shows a double row arrangement of the pressing parts 18.

The joining punch 10 according to FIG. 8 shows an arrangement of the pressing parts 18 along a square.

The joining punch 10 according to FIG. 9 shows an arrangement of the pressing parts 18 along a rectangle. Also here the numbers of the pressing parts 18 along the narrow sides differ from those of the wide sides.

FIG. 10 shows a schematic cross-sectional view of a cutout of another joining punch 10 clamping onto the first joining part 102.

It can be seen that a force transmission member 22 is arranged between the joining punch 10 and the first joining part 102. The force transmission member 22 is made of an elastic material such as a polymer. The pressing parts 18 are located at least partially in connection points 24 of the force transmission member 22 formed as bores.

Due to the elasticity of the force transmission member 22, the force transmission member 22 nestles against the first joining part 102. The force transmission member 22 therefore acts as an elastic mediating layer. Therefore, an additionally improved, particularly even force distribution or pressure distribution can be achieved using this joining punch 10.

FIG. 11 shows a joining device 26 having a further joining punch 10 in a schematic representation. It can be seen that the joining punch 10 clamps the two joining parts 102, 104 together using a layer of adhesive agent 106 located between them. For this purpose, the second joining part 104 is fixed on a work-part carrier 27 of the joining device 26.

A special feature of the joining punch 10 shown here is that its load-conducting parts 14 and its force-receiving part 12 are made of a controllably deformable material, in particular a bimetal. A control laser 28, in this case a laser scanner, can therefore use a control beam 30 to heat the force-receiving part 12 and/or one or a plurality of the load-conducting parts 14, in particular selectively, as required. As a result—as sketched in the cutout A—there is a deformation of the respective force-receiving part 12 or of the respective load-conducting part 14, so that the pressing parts 18 marked with reference marks in FIG. 11 are (slightly) lifted.

When the force-receiving part 12 cools down again, it returns to its original shape, as a result of which the pressing parts 18 are also shifted back to their original position.

Therefore, the force distribution of this joining punch 10 can be individually adjusted temporarily, especially during a joining process, by controlling the control laser 28 accordingly.

Preferably the load-conducting parts 14 and/or the force-receiving part 12 in this embodiment of the joining punch 10 are formed in such a manner that they are flexible. Furthermore, at least the load-conducting parts 14, which are to be shifted by such a load-conducting part 14 or force-receiving part 12 to be controlled by heating or cooling, can be non-rotatably connected in this embodiment to the load-conducting part 14 or force-receiving part 12 located above them. In this way, it can be avoided that the tilting of the load-conducting parts 14 during a shift by heating or cooling,—said tilting in particular being due to gravity—partially or completely compensates for the shift, and thereby reduces or even eliminates the desired control effect.

In order to be able to improve the heat input and/or the heat discharge in such an embodiment of a joining punch 10, load-conducting parts 14 can—as shown in FIG. 12 and FIG. 13—be provided with control points 32 and/or with cooling ribs 34 (FIG. 13).

To heat or activate such a load-conducting part 14, the laser beam 30 (FIG. 11) can then be directed to the respective control point 32. In return, the load-conducting parts 14 can be rapidly cooled by means of the cooling ribs 34 and therefore also quickly returned to their original shape even after switching off the laser beam 30.

### REFERENCE CHARACTERS

10 Joining punch
12 Force-receiving part
13 Force-receiving point
14 Load-conducting part
16 Joint part
18 Pressing part
20 Reinforcing section
22 Force transmission member
24 Connection point
26 Joining device
27 Work-part carrier
28 Control laser
30 Control beam
32 Control point
34 Cooling rib
100 Assembly
102 First joining part
104 Second joining part
106 Adhesive agent
A Cutout
F Contact force
F1 to F11 Partial force
x, y, z Direction

What is claimed is:

1. A joining punch for a joining device that is configured for producing a joining connection between a first joining part and a second joining part, comprising:
at least one force-receiving part to which a contact force (F) can be applied, and
at least two pressing parts configured for applying pressure to the first joining part via the force receiving part,
wherein the at least two pressing parts are arranged and/or formed independently of one another on the joining punch in such a manner that they are tiltable relative to the force-receiving part.

2. The joining punch according to claim 1, wherein the joining punch has at least one load-conducting part which is arranged between at least one of the two pressing parts and the force-receiving part, wherein the load-conducting part is arranged and/or formed on the joining punch so as to be tiltable relative to the force-receiving part.

3. The joining punch according claim 1, wherein at least one pressing part and/or one load-conducting part is arranged and/or formed on the joining punch in such a manner so as to be tiltable via a joint part.

4. The joining punch according claim 3, wherein the joint part is formed as a constriction.

5. The joining punch according to claim 1, wherein the pressing parts are arranged across an area formed by a polygonal, an at least substantially polygonal, an elliptical or an at least substantially elliptical surface and/or along such a surface contour.

6. The joining punch according to claim 1, wherein the joining punch tapers in a direction (x, y, z) parallel to a clamping direction and towards the force-receiving part.

7. The joining punch according to claim 2, wherein the at least one load-conducting part has a reinforcing section for stiffening parallel to a clamping direction.

8. The joining punch according to claim 2, wherein the at least one load-conducting part is arranged and/or formed in an asymmetrically hinged manner.

9. The joining punch according to claim 1, wherein the joining punch has, in a region of at least one of the pressing parts, an elastically deformable, force transmission member.

10. The joining punch according to claim 9, wherein at least one of the pressing parts is configured to be at least partially embedded in the force transmission member.

11. The joining punch according to claim 2, wherein the at least one load-conducting part has a controllably deformable material and/or wherein the at least one load-conducting part is formed from such a controllably deformable material.

12. The joining punch according to claim 2, wherein a plurality of the load-conducting parts and/or the force-receiving part are formed together in one piece.

13. The joining punch according to claim 1, wherein the joining punch has at least one part produced by 3D printing, by injection molding, by milling, by laser cutting and/or by eroding.

14. The joining punch according to claim 2, wherein at least one load-conducting part and/or the force-receiving part are formed so as to be at least partially elastically deformed.

15. A joining device having a joining punch according to claim 1.
